(19) United States
(12) Patent Application Publication
(10) Pub. No.: US 2026/0230379 A1
(43) Pub. Date: Aug. 6, 2026

(54) SERVICE-AWARE NETWORKING IN PRIVATE NETWORKS

(71) Applicant: Tailscale Inc., Toronto (CA)

(72) Inventors: Maisem J. Ali, Woodinville, WA (US); Adrian Dewhurst, Wellesley (CA); Kabir Sikand, Brooklyn, NY (US); Irbe Krumina, Newqay (GB)

(21) Appl. No.: 19/465,342

(22) Filed: Jan. 30, 2026

Related U.S. Application Data
(60) Provisional application No. 63/752,358, filed on Jan. 31, 2025.

(51) Int. Cl. H04L 41/0803

(52) U.S. Cl. CPC H04L 41/0803

(57) ABSTRACT

The disclosure describes a system for service-aware networking in a private network. In one implementation, a coordination service of the private network obtains a definition of a service comprising a network-addressable identifier. The coordination service receives an advertisement from a node participating in the private network indicating that the node is available to act as a destination for the service. The coordination service authorizes the node to act as the destination for the service and distributes service-resolution information to a plurality of nodes in the private network, the service-resolution information identifying the node as an authorized destination for the service. The distributed service-resolution information enables nodes of the private network to communicate with the service independently of underlying network topology or resource location while maintaining centralized authorization and policy control.

### CROSS-REFERENCE TO RELATED APPLICATIONS

This Application claims priority to U.S. Provisional Patent Application No. 63/752,358 titled “SERVICE-AWARE NETWORKING OVER TAILSCALE,” filed January 31, 2025, the contents of which are incorporated by reference in its entirety for all purposes.

### BACKGROUND

Private networks, such as private overlay networks, commonly implement participating devices as nodes that communicate with one another, for example using encrypted tunnels. In many deployments, however, organizations wish to access or expose computing resources that are not themselves implemented as nodes of the private network. For example, organizations increasingly utilize orchestration platforms (such as Kubernetes clusters) that host ephemeral containers, which may be impractical or inefficient to individually configure as nodes of a private overlay network. In addition, nodes of a private network may be connected to other resources, such as databases, services, or devices, that are external to the private network and do not participate directly as nodes. As a result, challenges arise in efficiently and securely enabling communication between nodes of a private network and such non-node resources.

In existing systems, access to resources is often controlled using policies that are defined in terms of individual nodes, network addresses, or static network topology. Such approaches can be difficult to manage when resources are dynamic, replicated, or reachable through intermediary nodes. For example, changes in which node provides access to a given resource may require manual updates to access policies, configuration of multiple network addresses, or reconfiguration of client devices. These limitations are exacerbated in environments that include a large number of resources, such as deployments with hundreds or thousands of services or ephemeral workloads, where frequent changes can significantly increase operational complexity.

### SUMMARY

The disclosure describes systems and methods for enabling service-oriented connectivity and access control within a private network. In one implementation, a method includes obtaining, at a coordination service of a private network, a definition of a service comprising a network-addressable identifier. The method further includes receiving, at the coordination service, an advertisement from a first node participating in the private network, the advertisement indicating that the first node is available to act as a destination for the service. The method further includes authorizing, by the coordination service, the first node to act as the destination for the service. The method further includes distributing, by the coordination service, service-resolution information to a plurality of nodes in the private overlay network, the service-resolution information identifying the first node as an authorized destination for the service. Through these operations, the disclosed systems and methods enable nodes of the private network to communicate with services independently of the particular nodes or network locations through which the services are made available, while maintaining centralized policy control.

These and other features and aspects of various examples may be understood in view of the following detailed discussion and accompanying drawings.

### BRIEF DESCRIPTION OF THE DRAWINGS

FIG. 1 illustrates a network environment in an implementation.

FIG. 2 illustrates a process for service-aware networking in an implementation.

FIG. 3 illustrates an operational sequence in an implementation.

FIGS. 4A-4B illustrates a workflow in the context of the network environment of FIG. 1.

FIG. 5 illustrates a process for service-aware node communication in an implementation.

FIG. 6 illustrates a computing system suitable to implement the various devices, architectures, processes, workflows, and sequences described herein.

### DETAILED DESCRIPTION

The disclosure describes systems and methods for enabling service‑oriented networking within a private network, in which network‑reachable resources are exposed and accessed through logical services that are defined independently of any particular device, network address, or topology. In the disclosed approach, a coordination service maintains service definitions separate from participating nodes, authorizes nodes to dynamically associate with services as destinations, and distributes service‑resolution information that enables other nodes to communicate with services without direct awareness of underlying resource location or implementation. By decoupling service identity, authorization, and routing from individual nodes and static network topology, the disclosed systems provide centralized, policy‑driven access to services that may be dynamic or ephemeral, while reducing configuration complexity and improving scalability in private networks.

In general, the disclosed systems operate in the context of a private network, such as a private overlay network, in which participating devices communicate using secure connections. The private network includes a plurality of nodes, each node being a computing device configured to participate in the private network and communicate with other nodes. In addition to such nodes, the private network is used to access one or more resources that do not themselves participate as nodes of the private network. Such resources may include computing services, databases, containers of an orchestration platform, devices, or other network-accessible resources that are reachable by one or more nodes of the private network.

The system further includes a coordination service that maintains information describing available services within the private network. A service represents a definition associated with a resource and is defined independently of any particular node. Each service is associated with a network-addressable identifier that enables nodes of the private network to reference the service without regard to the underlying location or implementation of the resource. The coordination service maintains service definitions and manages associations between services and nodes that are authorized to act as destinations for those services.

Nodes participating in the private network may advertise their availability to act as destinations for one or more services. An advertisement indicates that a given node is capable of receiving communications associated with a service and delivering such communications to a resource reachable by the node (also referred to as a “connected resource”). In response to such advertisements, the coordination service evaluates authorization criteria, which may be specified by an administrator of the private network, to determine whether an advertising node is permitted to act as a destination for the service. Authorization may be performed based on explicit administrative approval, automatically based on predefined criteria, or a combination thereof.

As used herein, the term “node” refers to a computing system or device that is registered with the coordination service and participates in the private network, including computing systems, user devices, and other authorized computing systems. In some implementations, a node executes client software that enables the node to participate in the private network. The client software may manage registration with the coordination service, establishment of secure communication channels with other nodes, and transmission and receipt of communications over the private network, including encapsulation and decapsulation of packets exchanged between nodes.

Upon authorizing one or more nodes as destinations for a service, the coordination service distributes service-resolution information to nodes of the private network. The service-resolution information identifies one or more authorized destination nodes for the service and enables consuming nodes to resolve the service to an appropriate destination node. Nodes that receive the service-resolution information may thereafter initiate communications addressed to the service, select an authorized destination node based on the service-resolution information, and direct the communications to the selected destination node.

When a destination node receives communications associated with a service, the destination node forwards the communications to the resource associated with the service and reachable by the destination node. The resource itself need not participate in the private network, and the manner in which the destination node delivers communications to the resource may vary depending on the implementation. For example, the destination node may forward communications over a local network, routed subnet, virtual private cloud, peered network, or other network connection to a resource executing on a separate computing system, without requiring the resource to participate as a node of the private network.

The private network employs packet encapsulation to enable secure communications between registered nodes, such as consuming nodes and destination nodes, over an underlying public communication network. When a first node (e.g., a consumer node) of the private network transmits data to a second node (e.g., a destination node), the first node generates an original packet containing a data payload and an inner packet header that identifies the second node within the private network. The first node encapsulates the original packet within an outer packet configured for transmission over the public communication network. Encapsulation may include encrypting the original packet using cryptographic information associated with the second node and adding an outer packet header that directs the encapsulated packet to a network address associated with the second node on the public communication network. The encapsulated packet is transmitted over the public communication network and, upon receipt at the second node, is decapsulated and decrypted. The resulting packet is then processed as a communication received via the private network, enabling secure node-to-node communications independent of the underlying network infrastructure.

In some implementations, nodes of the private network establish secure communication channels using cryptographic information, such as public and private keys, to derive shared cryptographic material that is used to encrypt and decrypt communications exchanged between the nodes. In such implementations, the cryptographic information used in encapsulation and decapsulation may include one or more shared keys derived during establishment of the secure communication channel. In other implementations, secure communications between nodes may be achieved using different cryptographic techniques, including techniques in which public-key cryptographic information is used directly to encrypt and decrypt individual communications or packets.

By defining services as logical network endpoints that are created, authorized, and resolved through a coordination service, the disclosed approach allows network traffic to be associated with approved service destinations dynamically, rather than being bound to specific devices or fixed network addresses. As a result, consuming nodes can access services using stable identifiers without requiring reconfiguration when underlying resources change. This architecture reduces network configuration overhead, supports scalable access to dynamic or ephemeral resources, and enables centralized enforcement of access rules at the service level. These capabilities improve the efficiency, flexibility, and security of private networks that connect nodes to resources that may not themselves participate as network nodes.

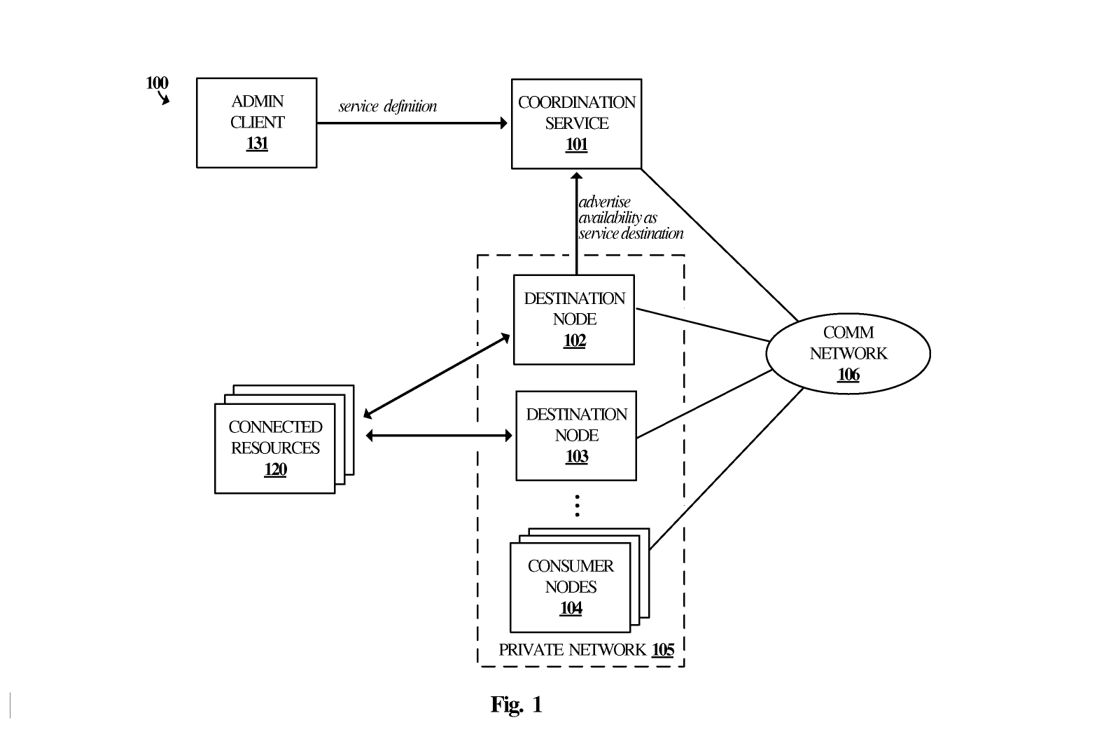

FIG. 1 illustrates network environment 100 in an implementation. Network environment 100 includes admin client 131, coordination service 101, connected resources 120, private network 105, and communications network 106. Private network 105 is a private network, such as a virtual private network (VPN) or, in some examples, a physical private network, that restricts participation to authenticated computing systems registered with the network. Private network 105 may use cryptographic authentication mechanisms to ensure that only authorized computing systems are permitted to join the private network as nodes. In some embodiments, private network 105 is implemented as an overlay network established over underlying physical networking hardware, including wired and/or wireless communication links, routers, switches, firewalls, computing devices, or other components suitable for providing network communications between computing systems. At least a portion of the physical networking hardware may be included in, or underlie, communication network 106. Communication network 106 may include one or more local area networks, wide area networks, cellular networks, satellite networks, the Internet, or combinations thereof. Private network 105 enables secure communications between registered nodes over communication network 106 without requiring direct trust in the underlying communication infrastructure.

In some implementations, private network 105 is implemented as an overlay network using packet encapsulation. For example, when consumer node 104 transmits data to destination node 102, consumer node 104 encrypts and encapsulates an original packet within an outer packet configured for transmission over communication network 106. The outer packet may include addressing information enabling delivery of the encapsulated packet to destination node 102 over communication network 106. Upon receipt at destination node 102, the encapsulated packet is decapsulated and processed as a communication received via private network 105.

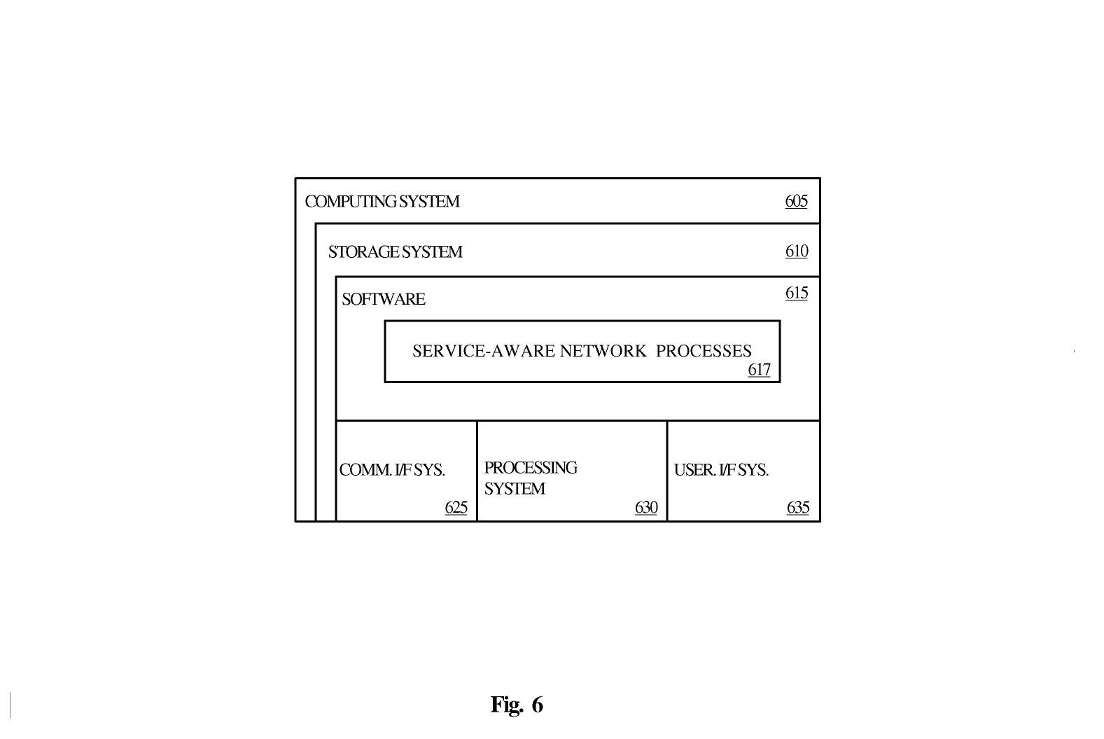

Coordination service 101 is representative of a service configured to manage participation in private network 105. Coordination service 101 may authenticate computing systems, register authenticated computing systems as nodes of private network 105, and distribute cryptographic information used to establish secure communication channels between registered nodes. Coordination service 101 may be implemented as a dedicated computing system (such as computing system 605 of FIG. 6), a virtualized computing system, or a component of another computing system associated with private network 105. In some examples, coordination service 101 is implemented as a node of private network 105. In other examples, coordination service 101 is external to private network 105 and communicates with nodes of private network 105 using network addresses over communication network 106. Computing systems that fail authentication or are otherwise not authorized are prevented from joining private network 105 as nodes.

Admin client 131 represents a device or application interfacing with coordination service 101 of private network 105 to perform administrative functions. Such administrative functions may include defining services and approving nodes to act as destinations for services. Admin client 131 may be represented by computing system 605 of FIG. 6.

Admin client 131 establishes services as logical, network-addressable objects within private network 105 that are defined independently of any particular destination node at the time of creation. Defining a service includes creating or registering a service definition that is resolvable within a private name-resolution system associated with the private network, such as an internal DNS namespace. The service definition provides a stable identifier by which consuming nodes may reference the service, even when no nodes are initially authorized to act as destinations for the service.

Nodes may subsequently advertise availability to act as destinations for the service. Authorization of such nodes is performed by coordination service 101, for example based on administrative approval. Upon authorizing one or more nodes as destinations for the service (e.g., destination nodes 102, 103), coordination service 101 updates the service definition to identify the authorized destination nodes for use in service resolution.

Destination nodes 102, 103 and consumer nodes 104 represent nodes in private network 105 configured to communicate with one another using secure communication channels of private network 105. In some examples, nodes 102, 103, 104 execute client software configured to handle authentication to private network 105, encryption and encapsulation of packets for transmission over private network 105, decryption and decapsulation of packets received over private network 105, and establishment and maintenance of secure communication channels between nodes. In some examples, nodes 102, 103, 104 execute respective client software configured to support communications over private network 105. The client software may handle authentication to private network 105, encapsulation and decapsulation of communications, and establishment and maintenance of secure communication channels between nodes.

Destination nodes 102, 103 represent nodes advertised and authorized as service destinations for services defined via admin client 131. Destination nodes 102, 103 are configured

to interface with connected resources 120 that provide functionality associated with the services. Connected resources 120 may include, for example, databases, containerized applications hosted by an orchestration platform, or other network-accessible devices. In some implementations, connected resources 120 do not participate as nodes of private network 105. Communications addressed to a service are received by destination node 102 or destination node 103 and forwarded by destination node 102 or destination node 103 to connected resource 120 associated with the service.

In some implementations, connected resources 120 are implemented in computing elements (e.g., devices, virtual machines, and containerized applications) external to private network 105 and not implemented as nodes in the private network. However, it should be noted that destination nodes 102, 103 may themselves implement connected resources 120 internally (e.g., as part of the computing system or device implementing the destination node 102 or 103). For example, a connected resource 120 (e.g., a database resource) may exist as a separate software application running on destination node 102 or 103. Various implementations may include combinations of connected resources 120 external to private network 105 and connected resources 120 implemented within destination nodes 102, 103. In general, a node may advertise ability as a destination for a service if a connected resource 120 is reachable by the node, either internally to the node itself or externally.

In some implementations, a destination node itself hosts or executes a resource that performs functionality associated with a service. In such implementations, destination node 102 or destination node 103 may process communications associated with the service locally, without forwarding the communications to a separate connected resource 120.

Consumer nodes 104 represent nodes of private network 105 configured to initiate communications addressed to services defined within private network 105. Consumer nodes 104 may include computing systems operated by users, automated processes, applications, or other network participants that require access to functionality provided by connected resources 120 via services. Consumer nodes 104 participate in private network 105 as authenticated nodes and communicate with other nodes using secure communication channels established by private network 105.

Consumer nodes 104 may maintain service-resolution information received from coordination service 101. The service-resolution information identifies one or more destination nodes authorized to act as destinations for a service. When consumer node 104 obtains a request to communicate with a service, consumer node 104 uses the service-resolution information to select an authorized destination node and transmit a communication to the selected destination node over private network 105.

In particular, consumer node 104 may transmit encapsulated communications addressed to a network address of the selected destination node to reach a service, without requiring knowledge of network addressing or location details of connected resource 120 associated with the service. Authorization of destination nodes and availability of service-resolution information remain centrally managed by coordination service 101, such that access control for the service is enforced through authorization and distribution of service-resolution information.

It should be noted that the terms consumer nodes and destination nodes are used for purposes of clarity. However, in various implementations, a given node of private network 105 may act as a consumer node with respect to one service and as a destination node with respect to another service. A node may therefore initiate communications addressed to one or more services while also being authorized to receive communications as a destination for one or more other services. The roles of consumer and destination are determined based on service definitions and authorization state maintained by coordination service 101, rather than being fixed attributes of individual nodes.

In one example workflow, admin client 131 submits a service definition associated with a database to coordination service 101. The service definition includes a network-addressable identifier that may be used by nodes of private network 105 to reference the database service. The database itself may be implemented as connected resource 120, such as a database instance executing within an orchestration platform or on a computing system external to private network 105, and may not participate directly as a node of private network 105. Destination node 102, which has network connectivity to connected resource 120, advertises availability to act as a destination for the database service. Coordination service 101 evaluates the advertisement and authorizes destination node 102 to act as a destination for the database service, for example based on administrative approval or predefined authorization criteria.

Following authorization, coordination service 101 distributes service-resolution information identifying destination node 102 as an authorized destination for the database service to one or more consumer nodes 104 of private network 105. Consumer node 104 maintains the service-resolution information and, when an application executing on consumer node 104 requests access to the database service, consumer node 104 resolves the service to destination node 102 using the service-resolution information. Consumer node 104 then transmits communications associated with the database service to destination node 102 over private network 105. Upon receipt, destination node 102 forwards the communications to connected resource 120 providing the database functionality. In this manner, consumer node 104 accesses the database service without requiring awareness of the location, network address, or implementation details of connected resource 120, and without requiring direct participation of connected resource 120 as a node of private network 105.

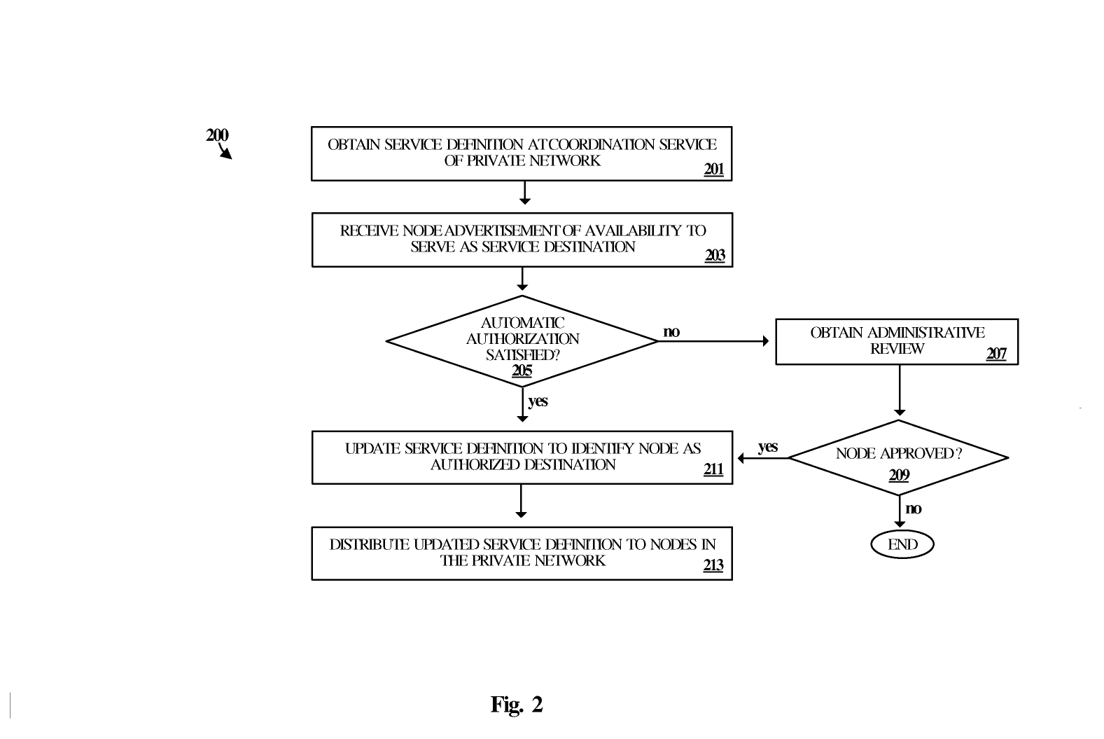

FIG. 2 illustrates a service-networking process, represented by process 200. Process 200 is employed by one or more computing devices, an example of which is provided by computing system 605 of FIG. 6. Process 200 may be implemented in program instructions (software and/or firmware) by one or more processors of the computing device. The program instructions direct the computing device to operate as follows, referring to the steps in FIG. 2.

Step 201 of process 200 includes obtaining a service definition at coordination service 101 of private network 105. The service definition may be obtained from admin client 131, for example based on user input of service parameters provided via a user interface of admin client 131. The service definition may include a network-addressable identifier for the service and may further include metadata associated with the service.

Step 203 of process 200 includes receiving, at coordination service 101, an advertisement from a node of private network 105 indicating availability of the node to act as a destination for the service. The advertisement may identify the service and indicate that the advertising node is capable of receiving communications associated with the service and forwarding the communications to a connected resource reachable by the node.

Step 205 of process 200 includes determining whether authorization of the advertising node is automatically permitted. The determination may be based on one or more predefined authorization criteria associated with the service, such as attributes of the advertising node, membership of the advertising node in one or more groups or tags, or policies specified by an administrator of private network 105.

If authorization is not automatically permitted, process 200 proceeds to step 207, which includes obtaining administrative review of the advertisement. In step 207, coordination service 101 may present information associated with the advertisement to an administrator via admin client 131. The information may include, for example, an identity of the advertising node, an identifier of the service, attributes of the advertising node, and any other applicable authorization criteria. Admin client 131 may provide a user interface through which the administrator reviews the advertisement and provides an approval or a denial.

Step 209 includes determining whether the advertising node is approved to act as a destination for the service based on input received from admin client 131. If the advertising node is approved, process 200 proceeds to update the service definition in step 211 described below. If the advertising node is not approved, process 200 may end without updating the service definition and without authorizing the advertising node as a destination for the service.

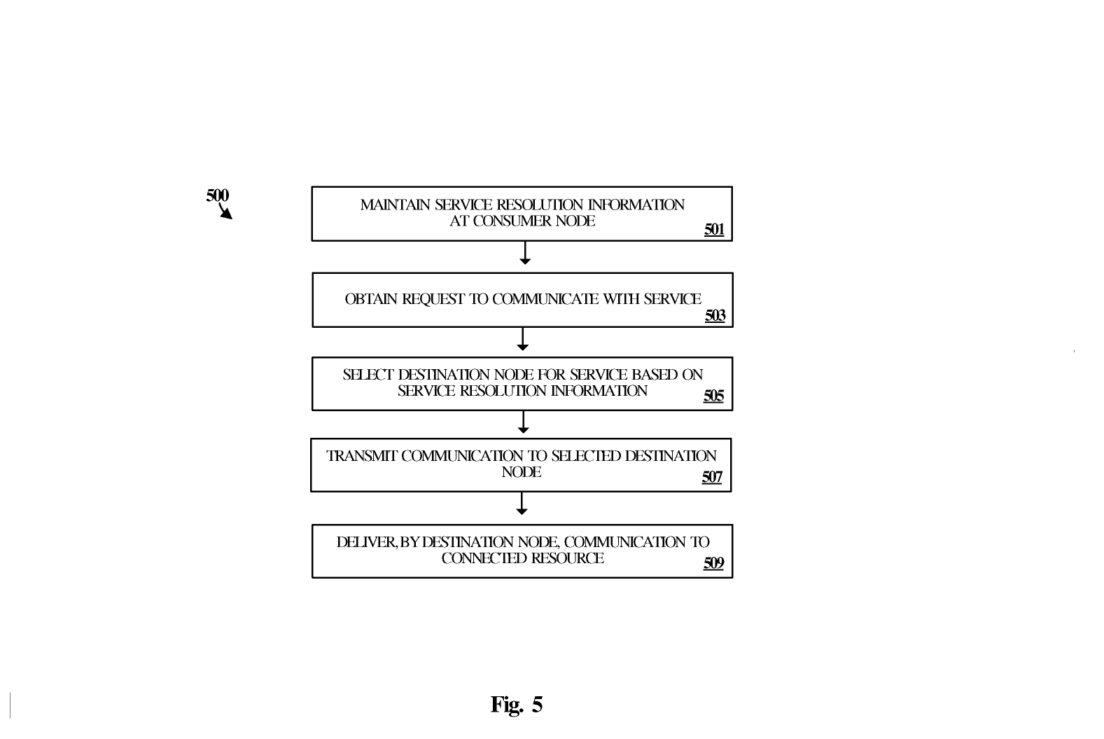

If authorization is automatically permitted at step 205 or approval is received at step 209, process 200 proceeds to step 211, which includes updating the service definition to include an identification of the advertising node as a destination for the service. Step 213 of process 200 includes distributing updated service-resolution information to nodes 102, 103, 104 of private network 105, the service-resolution information identifying the authorized destination node for the service. Consumer nodes 104 may then use the service-resolution information to direct traffic to destination nodes 102, 103 for the service, as described further below in relation to process 500 of FIG. 5.

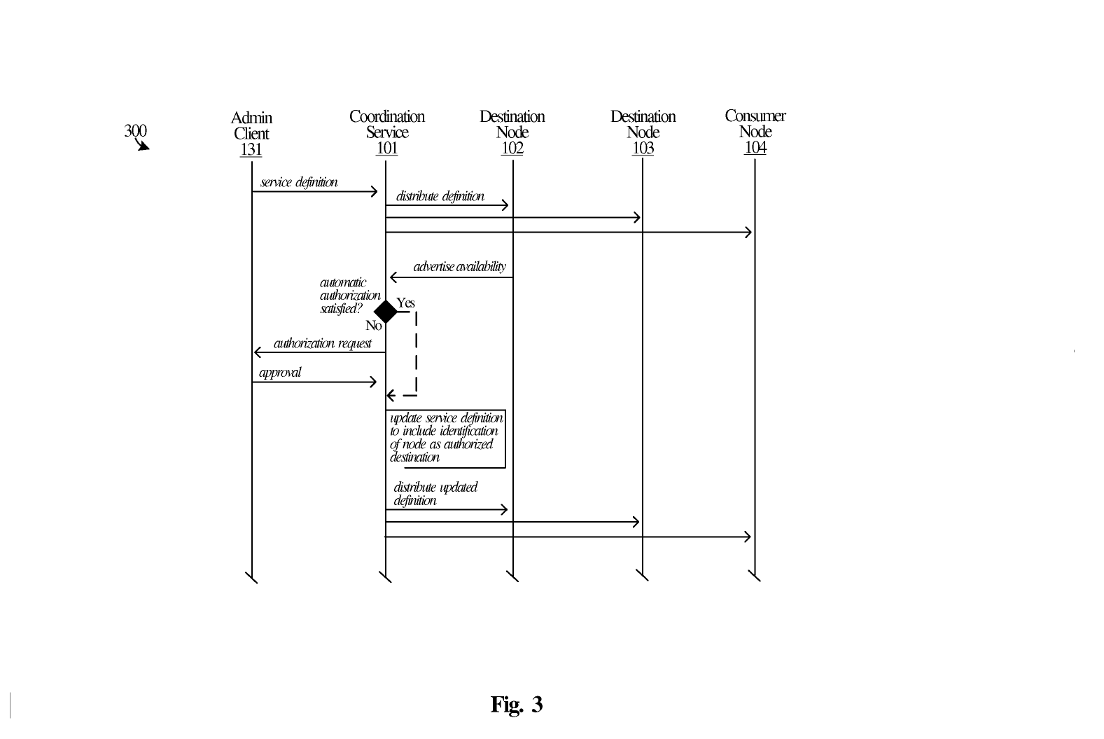

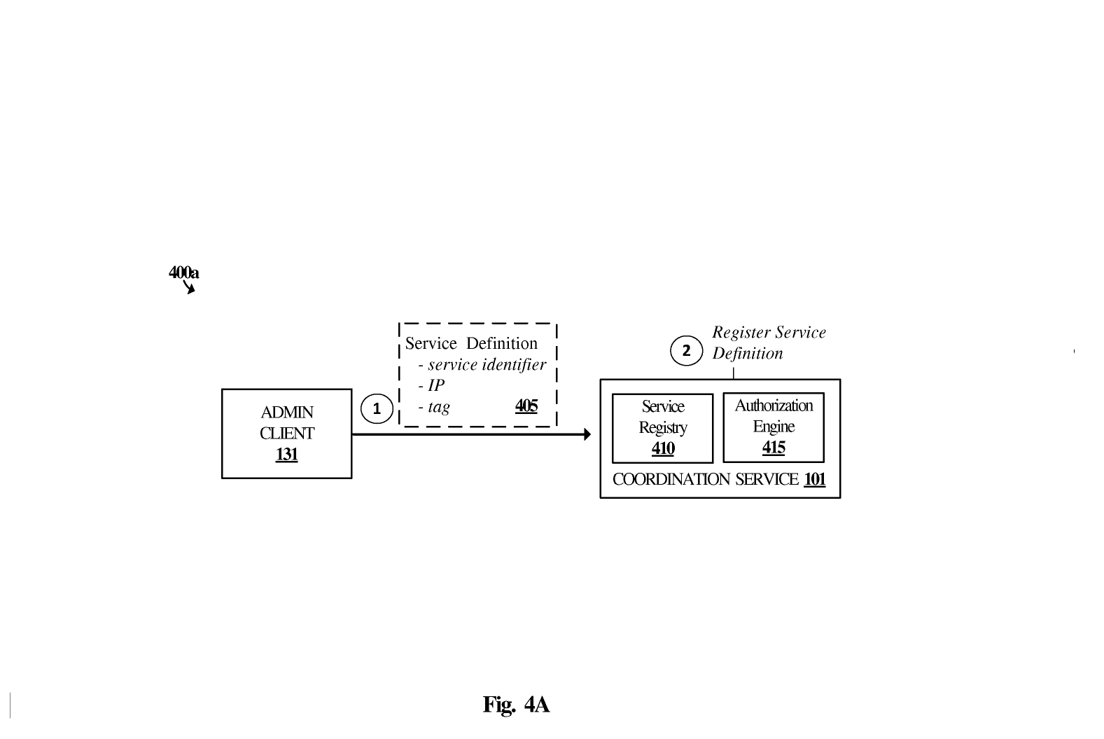

FIG. 3 illustrates an operation sequence in the context of network environment 100 in an implementation, represented by sequence 300. Sequence 300 includes admin client 131, coordination service 101, destination nodes 102, 103, and consumer node 104.

In sequence 300, admin client 131 provides a service definition to coordination service 101. The service definition identifies a service to be made available within private network 105 and may include a network-addressable identifier and associated metadata. In response to receiving the service definition, coordination service 101 distributes the service definition to nodes of private network 105, including destination nodes 102, 103 and consumer node 104.

Destination node 102 transmits an advertisement to coordination service 101 indicating availability of destination node 102 to act as a destination for the service. The advertisement may identify the service and indicate that destination node 102 is capable of receiving communications associated with the service and forwarding the communications to a connected resource reachable by destination node 102.

Upon receiving the advertisement, coordination service 101 determines whether authorization of destination node 102 to act as a destination for the service is automatically permitted. The determination may be based on predefined authorization criteria associated with the service. If automatic authorization is not satisfied, coordination service 101 transmits an authorization request to admin client 131.

Admin client 131 provides an approval in response to the authorization request. Upon receiving the approval, coordination service 101 authorizes destination node 102 to act as a destination for the service.

After authorizing destination node 102, coordination service 101 updates the service definition to include identification of destination node 102 as an authorized destination for the service. Coordination service 101 then distributes updated service-resolution information to nodes of private network 105, including destination nodes 102, 103 and consumer node 104.

As a result of sequence 300, consumer node 104 receives service-resolution information identifying destination node 102 as an authorized destination for the service. Consumer node 104 may thereafter resolve the service to destination node 102 and transmit communications associated with the service to destination node 102 over private network 105.

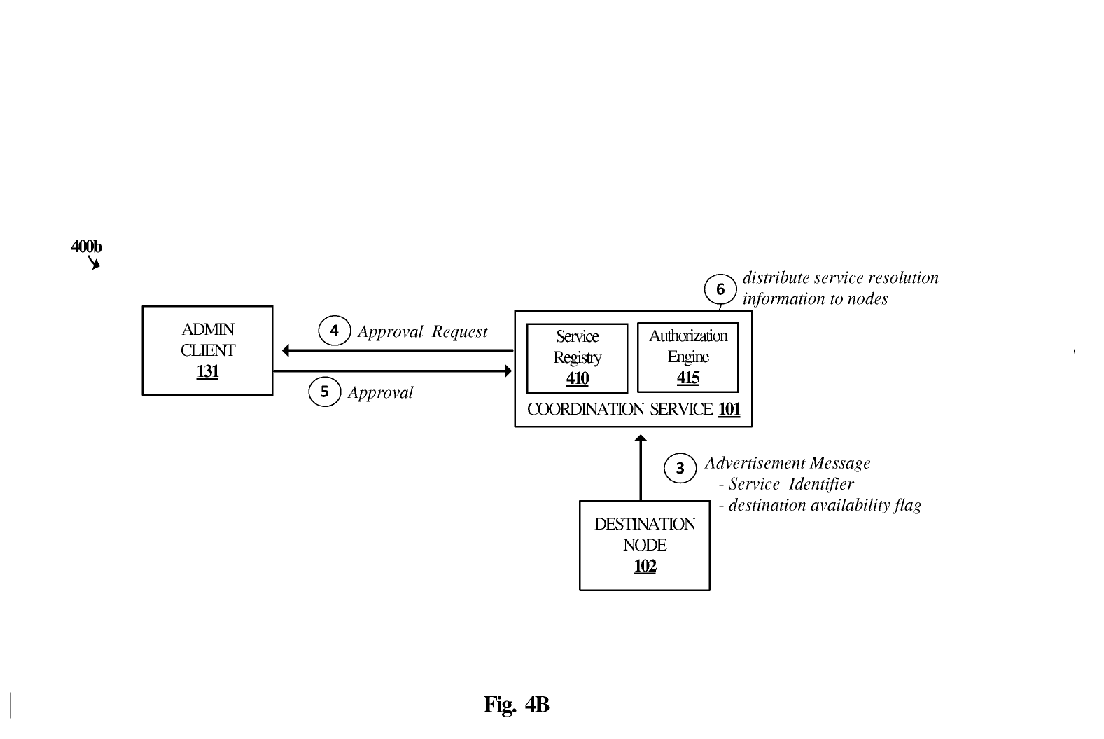

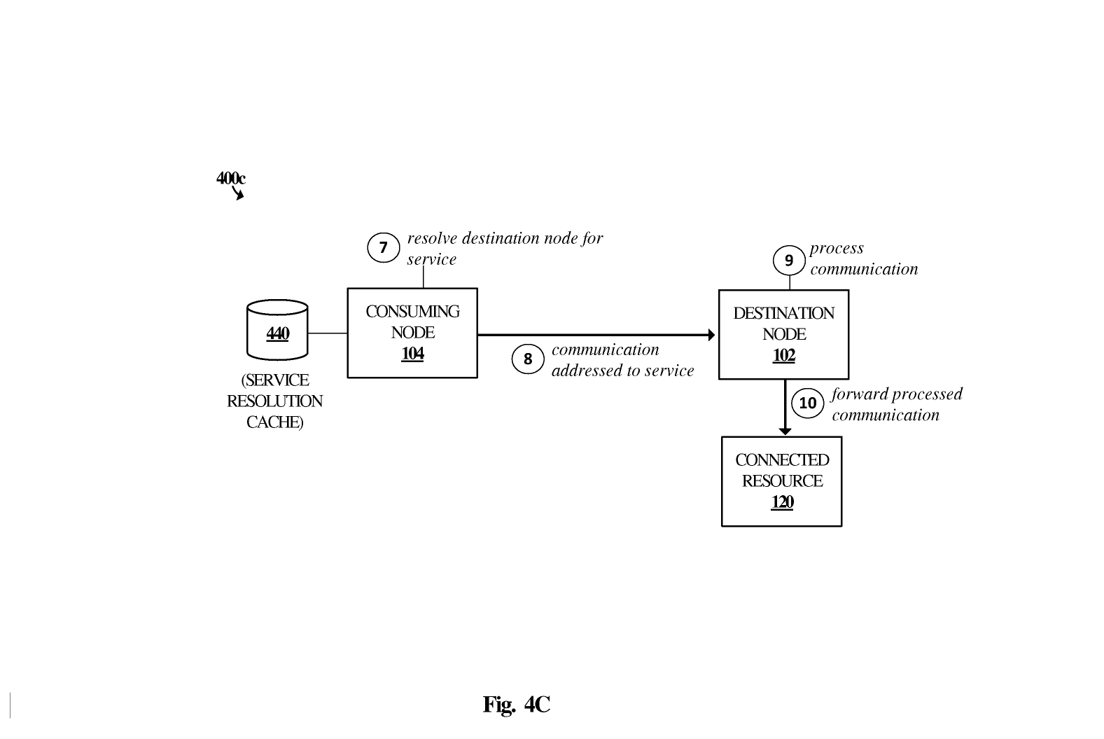

FIGS. 4A-4C illustrate various workflows in the context of network environment 100. Each workflow is discussed in turn below.

FIG. 4A illustrates a service-definition workflow in an implementation, represented by workflow 400a. Workflow 400a includes admin client 131 and coordination service 101.

In workflow 400a, admin client 131 submits a service definition 405 to coordination service 101. The service definition 405 specifies one or more attributes describing a network-accessible resource, such as a database service, including a service identifier (e.g., “staging-db”), network addressing information, and tags (e.g., “staging”).

In some implementations, the service identifier specified in the service definition corresponds to a name that may be resolved by nodes of private network 105 using a private name resolution mechanism, such as a private domain name system. For example, the service identifier may be associated with a private DNS (Domain Name Service) record, such as a MagicDNS record, that resolves to one or more network addresses associated with the service. Such network addresses may include virtual network addresses assigned to the service or network addresses corresponding to authorized destination nodes for the service. Private DNS resolution in this manner enables consumer nodes 104 to reference the service using a stable, memorable name without requiring awareness of underlying network addresses or changes in which destination nodes provide access to the service.

In some implementations, the network addressing information includes one or more virtual network addresses associated with the service, such as a virtual IPv4 address and a virtual IPv6 address allocated from an address space associated with private network 105. The virtual network addresses may be distinct from network addresses assigned to destination nodes 102, 103 and may remain stable even as authorized destination nodes change over time. Consumer nodes 104 may address communications to a virtual network address of the service, and service-resolution information distributed by coordination service 101 enables consumer nodes 104 to map the virtual network address to an authorized destination node for delivery of the communications. In some implementations, a private DNS record associated with the service resolves to the virtual network address of the service. Use of virtual network addresses in this manner allows services to be addressed independently of specific destination nodes and supports dynamic reassignment, replication, or replacement of connected resources 120.

Upon receipt of a service definition, service registry 410 of coordination service 101 stores the service definition. Service registry 410 maintains indexed mappings between service identifiers and corresponding service metadata, including network-addressable identifiers, authorization attributes, and other descriptive information associated with the service. The service definition may be stored independently of any destination nodes authorized to act as destinations for the service.

Authorization engine 415 of coordination service 101 evaluates authorization requirements associated with the service definition and with advertisements received from nodes indicating availability to act as destinations for the service. Authorization engine 415 determines whether an advertising node is automatically authorized to act as a destination for the service based on predefined authorization criteria. The predefined authorization criteria may be derived from administrative input and may include, for example, attributes of the service, attributes of the advertising node, node classifications, tags, roles, or identity information.

If authorization engine 415 determines that an advertising node satisfies the predefined authorization criteria, coordination service 101 may automatically authorize the advertising node to act as a destination for the service and update the service definition accordingly. If authorization engine 415 determines that the advertising node does not satisfy the predefined authorization criteria, coordination service 101 may forward information associated with the advertisement to admin client 131 for administrative review. Admin client 131 may present the information to an administrator and receive an approval or denial indicating whether the advertising node is permitted to act as a destination for the service. The authorization decision, whether automatic or administratively approved, is recorded in the service definition maintained by service registry 410.

FIG. 4B illustrates an advertisement workflow in an implementation, represented by workflow 400b. Workflow 400b may be performed sequentially after workflow 400b. Workflow 400b includes admin client 131, coordination service 101, and destination node 102.

In workflow 400b, destination node 102 transmits an advertisement message to coordination service 101 indicating availability to host or provide the defined service. The advertisement message may include a service identifier and an availability indicator associated with the destination node. In the database example, the destination node may correspond to a database instance or a computing device able to access an external database resource (e.g., connected resource 120).

Coordination service 101 associates the advertisement message with the corresponding service record stored in service registry 410. In some implementations, coordination service 101 (e.g., authorization engine 415) determines that administrative approval is required before the destination node may be exposed to consumer nodes for the service.

Accordingly, coordination service 101 issues an approval request to admin client 131. The approval request may identify the service and the destination node seeking to advertise availability.

Admin client 131 provides an approval response to coordination service 101 indicating whether the destination node is approved to participate in the service. The approval response may be entered by a human administrator or generated based on predefined rules, or policy evaluation.

Upon receiving approval, coordination service 101 updates the service registry and authorization engine to reflect the approved association between the service and the destination node. Coordination service 101 then distributes service resolution information to one or more nodes, enabling authorized consumer nodes to discover the approved destination node for the service.

FIG. 4C illustrates a node communication workflow in an implementation, represented by workflow 400c. Workflow 400c includes consuming node 104, destination node 102, and connected resource 120.

In workflow 400c, consuming node 104 obtains service resolution information distributed by coordination service 101 for an approved service. The service resolution information identifies one or more approved destination nodes (e.g., node 102) associated with the service and may include connection parameters and authorization context. Consuming node 104 may maintain the service-resolution information in service-resolution cache 440.

Based on the service-resolution information, consuming node 104 initiates a communication session with destination node 102. In some implementations, the communication session is established using an overlay or private-network connection provided by private network 105, without direct exposure of destination node 102 to communication network 106. To transmit communications associated with the service, consuming node 104 generates an inner packet containing a payload associated with the service and addressing information identifying destination node 102 within private network 105. The inner packet is encapsulated within an outer packet configured for transmission over communication network 106, the outer packet including a destination address corresponding to a public network address of destination node 102. The encapsulated packet is transmitted to destination node 102, where it is decapsulated and processed as a communication received via private network 105.

Destination node 102 receives the encapsulated communications from consuming node 104 and decapsulates the communications to obtain packets associated with the private-network connection. Destination node 102 validates the communication session and, upon successful validation, permits access to functionality associated with the service. In some implementations, destination node 102 forwards the decapsulated communications to connected resource 120 reachable by destination node 102. In other implementations, destination node 102 locally processes the communications to perform functionality associated with the service. In a database example, connected resource 120 corresponds to a database instance.

Once access is established, consuming node 104 exchanges application data with connected resource 120 via destination node 102. Workflow 400c thereby enables consuming nodes to securely access approved resources through destination nodes based on centrally managed service definitions, advertisements, and approvals, while decoupling service identity from underlying network topology.

FIG. 5 illustrates a node communications process, represented by process 500. Process 500 is employed by one or more computing devices, an example of which is provided by computing system 605 of FIG. 6. Process 500 may be implemented in program instructions (software and/or firmware) by one or more processors of the computing device. The program instructions direct the computing device to operate as follows, referring to the steps in FIG. 5.

Step 501 of process 500 includes maintaining service-resolution information at consumer node 104. The service-resolution information may be received from coordination service 101 and identifies one or more destination nodes approved to act as destinations for a service. The service-resolution information may include addressing data, service identifiers, and mapping metadata associating each service identifier with one or more destination nodes. In some implementations, service identifiers are resolved locally using an internal DNS of private network 105 that enables services to be referenced by stable, human-readable names within the private network environment.

Step 503 of process 500 is obtaining a request to communicate with the service. The request may originate from an application or workload executing on the consumer node 104 and may identify the service by its service identifier (e.g., name resolvable through private DNS), rather than by a specific IP address or network endpoint.

Step 505 of process 500 is selecting a destination node for the service based on the maintained service resolution information. Where more than one destination node is approved as a destination for the service (e.g., destination nodes 102, 103), consumer node 104 selects one of the destination nodes based on availability, policy, load balancing criteria, or other selection logic. The selection may be dynamic and context-sensitive, enabling adaptive routing to service endpoints.

Step 507 of process 500 includes transmitting a communication to the selected destination node. In some implementations, consumer node 104 transmits the communication over private network 105 using an encapsulated packet. The encapsulated packet includes an inner packet carrying a payload associated with the communication session and addressing information identifying the selected destination node within private network 105. The inner packet is encapsulated within an outer packet configured for transmission over communication network 106, the outer packet including a destination address corresponding to a public network address of the selected destination node. Authorization credentials or identity information associated with consumer node 104 may be presented as part of session establishment or maintained for use in validating the communication session at the selected destination node.

Step 509 of process 500 is delivering, by the destination node, the communication to a connected resource. The destination node receives the communication from the consumer node and forwards or proxies the communication to the connected resource associated with the service. In the database example, the connected resource corresponds to a database instance, and the communication may include database queries or transactions subject to the service’s access policies.

Process 500 thereby enables a consumer node to communicate with a service-defined resource through a destination node using centrally managed service resolution information, while abstracting the identity of the service from underlying network topology and resource location.

FIG. 6 illustrates computing system 605 which is representative of any system or collection of systems in which the various applications, processes, services, and scenarios disclosed herein may be implemented. Examples of computing system 605 include, but are not limited to server computers, web servers, cloud computing platforms, and data center equipment, microcontrollers, micro-controller units (MCUs), as well as any other type of physical or virtual server machine, container, and any variation or combination thereof. In some examples, computing system 605 may also be representative of desktop and laptop computers, tablet computers, and the like. Computing system 605 is representative of a cloud computing device, distributed computing device, or the like in some embodiments. Computing system 605 is generally representative of a computing device sufficient to execute private network operations discussed herein.

Computing system 605 is representative of a computing device sufficient to execute software and communicate with peripherals. Computing system 605 is representative of any system or collection of systems with which the various operational architectures, processes, scenarios, and sequences disclosed herein may be implemented. Computing system 605 may be implemented as a single apparatus, system, or device or may be implemented in a distributed manner as multiple apparatuses, systems, or devices. Computing system 605 includes, but is not limited to, storage system 610, software 615, communication interface system 625, processing system 630, and optional user interface system 635. Processing system 630 is operatively coupled with storage system 610, communication interface system 625, and user interface system 635.

Processing system 630 loads and executes software 615 from storage system 610. Software 615 includes and implements service-aware network processes 617, which are representative of the software components (e.g., coordination service 101, nodes 102, 103, 104 and connected resources 120) and the processes (e.g., processes 200, 500) discussed with respect to the preceding Figs. When executed by processing system 630, software 615 directs processing system 630 to operate as described herein for at least the various processes, operational scenarios, and sequences discussed in the foregoing implementations or to implement software 615 as described herein. Computing system 605 may optionally include additional devices, features, or functionality not discussed for purposes of brevity.

Processing system 630 may include a microprocessor and other circuitry that retrieves and executes software 615 from storage system 610. Processing system 630 may be implemented within a single processing device but may also be distributed across multiple processing devices or sub-systems that cooperate in executing program instructions. Examples of processing system 630 include general purpose central processing units, graphical processing units, microcontroller units, application specific processors, integrated circuits, application specific integrated circuits, and logic devices, as well as any other type of processing device, combinations, or variations thereof.

Storage system 610 may include any computer readable storage media readable by processing system 630 and capable of storing software 615. Storage system 610 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a transitory form of signal transmission (often referred to as "signals per se"), such as a propagating electrical or electromagnetic signal or carrier wave.

In addition to computer readable storage media, in some implementations, storage system 610 may also include computer readable communication media over which at least some of software 615 may be communicated internally or externally. Storage system 610 may be implemented as a single storage device but may also be implemented across multiple storage devices or sub-systems co-located or distributed relative to each other. Storage system 610 may include additional elements, such as a controller capable of communicating with processing system 630 or other systems.

Software 615 (including service-aware network processes 617) may be implemented in program instructions and, when executed by processing system 630, can direct processing system 630 to operate as described with respect to the various operational scenarios, sequences, and processes illustrated herein. For example, software 615 includes program instructions for obtaining and validating service definitions.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number, respectively. The word "or," in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for", but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computer-implemented method for service-aware networking comprising:
obtaining, at a coordination service of a private network, a definition of a service comprising a network-addressable identifier;
receiving, at the coordination service, an advertisement from a first node participating in the private network, the advertisement indicating that the first node is available to act as a destination for the service;
authorizing, by the coordination service, the first node to act as the destination for the service; and
distributing, by the coordination service, service-resolution information to a plurality of nodes in the private network, the service-resolution information identifying the first node as an authorized destination for the service.

2. The computer-implemented method of claim 1, wherein the first node is configured to receive communications addressed to the service and deliver the communications to a resource reachable by the first node, the resource not participating as a node of the private network.

3. The computer-implemented method of claim 2, wherein the resource is selected from one of:
a computing resource of the first node;
a container of an orchestration platform reachable by the first node; and
a device reachable by the first node.

4. The computer-implemented method of claim 1, wherein the authorizing the first node to act as the destination for the service comprises receiving, at the coordination service, an approval from an administrative device associated with an administrator of the private network.

5. The computer-implemented method of claim 1, wherein the authorizing the first node to act as the destination for the service comprises:
determining, by the coordination service, that the advertisement from the first node satisfies one or more predefined authorization criteria specified by an administrator of the private network; and
in response to the determination, automatically authorizing the first node to act as the destination for the service.

6. The computer-implemented method of claim 1, wherein the service-resolution information identifies a plurality of destination nodes including the first node that are authorized to act as destinations for the service.

7. The computer-implemented method of claim 6, further comprising selecting, by a consumer node participating in the private network, one of the plurality of destination nodes for the service based on the service-resolution information distributed by the coordination service.

8. The computer-implemented method of claim 1, wherein the definition of the service is maintained by the coordination service in a defined state prior to any node being authorized to act as a destination for the service.

9. A system comprising:
one or more processors; and
one or more memories operably coupled to the one or more processors and having stored thereon software instructions that, upon execution by the one or more processors, cause the one or more processors to:
obtain a definition of a service comprising a network-addressable identifier;
receive an advertisement from a first node participating in a private network, the advertisement indicating that the first node is available to act as a destination for the service;
authorize the first node to act as the destination for the service; and
distribute service-resolution information to a plurality of nodes in the private network, the service-resolution information identifying the first node as an authorized destination for the service.

10. The system of claim 9, wherein the first node is configured to receive communications addressed to the service and deliver the communications to a resource reachable by the first node, the resource not participating as a node of the private network.

11. The system of claim 10, wherein the resource is selected from one of:
a computing resource of the first node;
a container of an orchestration platform reachable by the first node; and
a device reachable by the first node.

12. The system of claim 9, wherein the authorizing the first node to act as the destination for the service comprises receiving an approval from an administrative device associated with an administrator of the private network.

13. The system of claim 9, wherein the authorizing the first node to act as the destination for the service comprises:
determining that the advertisement from the first node satisfies one or more predefined authorization criteria specified by an administrator of the private network; and
in response to the determination, automatically authorizing the first node to act as the destination for the service.

14. The system of claim 9, wherein the service-resolution information identifies one or more nodes in addition to the first node that are authorized to act as destinations for the service.

15. The system of claim 9, wherein the definition of the service is maintained by a coordination service in a defined state prior to any node being authorized to act as a destination for the service.

16. A computer-readable storage media device having program instructions stored thereon to facilitate service-aware networking, wherein the program instructions, upon execution by one or more processors, cause the one or more processors to:
obtain a definition of a service comprising a network-addressable identifier;
receive an advertisement from a first node participating in a private network, the advertisement indicating that the first node is available to act as a destination for the service;
authorize the first node to act as the destination for the service; and
distribute service-resolution information to a plurality of nodes in the private network, the service-resolution information identifying the first node as an authorized destination for the service.

17. The computer-readable storage media device of claim 16, wherein the first node is configured to receive communications addressed to the service and deliver the communications to a resource reachable by the first node, the resource not participating as a node of the private network.

18. The computer-readable storage media device of claim 17, wherein the resource is selected from one of:
a computing resource of the first node;
a container of an orchestration platform reachable by the first node; and
a device reachable by the first node.

19. The computer-readable storage media device of claim 17, wherein the authorizing the first node to act as the destination for the service comprises receiving an approval from an administrative device associated with an administrator of the private network.

20. The computer-readable storage media device of claim 17, wherein the authorizing the first node to act as the destination for the service comprises:
determining that the advertisement from the first node satisfies one or more predefined authorization criteria specified by an administrator of the private network; and
in response to the determination, automatically authorizing the first node to act as the destination for the service.
